(19) United States
(12) Patent Application Publication
(10) Pub. No.: US 2024/0063426 A1
(43) Pub. Date: Feb. 22, 2024

(54) ALL SOLID BATTERY

(71) Applicant: SAMSUNG SDI CO., LTD., Yongin-si (KR)

(72) Inventors: Seonhyeok AN, Yongin-si (KR); Seunghyun OH, Yongin-si (KR); Mijung JUNG, Yongin-si (KR)

(21) Appl. No.: 18/236,067

(22) Filed: Aug. 21, 2023

(30) Foreign Application Priority Data
Aug. 22, 2022 (KR) 10-2022-0104754

(51) Int. Cl. H01M 10/0562; H01M 10/052; H01M 4/04

(52) U.S. Cl. CPC H01M 10/0562; H01M 10/052; H01M 4/0404

(57) ABSTRACT

An embodiment of the present disclosure provides an all-solid-state battery that improves ionic conductivity of a positive electrode plate. The all-solid-state battery includes: a positive electrode plate configured to include a positive electrode mixture layer on a positive electrode current collector; a solid electrolyte layer disposed at a first side of the positive electrode plate; and a negative electrode plate positioned at a first side of the solid electrolyte layer, wherein the positive electrode mixture layer forms a groove having a depth in a stacking direction, and the solid electrolyte layer further includes a charging portion filled in the groove.

### CROSS-REFERENCE TO RELATED APPLICATION

This application claims priority to and the benefit of Korean Patent Application No. 10-2022-0104754, filed in the Korean Intellectual Property Office on Aug. 22, 2022, the entire contents of which are incorporated herein by reference.

### BACKGROUND

### 1. Field

The present disclosure relates to an all-solid-state battery, and more particularly, to an all-solid-state battery that has increased ionic conductivity of a positive electrode plate.

### 2. Description of the Related Art

An all-solid-state battery includes a positive electrode plate, a solid electrolyte layer, and a negative electrode plate. The solid electrolyte layer is a medium that conducts lithium ions. In the case of a lithium precipitation-type all-solid-state battery, lithium ions moved from the positive electrode plate are deposited as a metal on the negative electrode plate to be accumulated, and a lithium metal is deposited on the negative electrode plate during charging regardless of presence or absence of an active material in the negative electrode plate.

An all-solid-state battery having a precipitation-type negative electrode plate does not have a housing during charging. Lithium ions moved from the positive electrode plate are deposited on the negative electrode plate. During discharging, lithium ions accumulated on the negative electrode plate are dissociated from the negative electrode plate and are moved back to the positive electrode plate.

As is known, methods for increasing ionic conductivity between the positive electrode plate and the negative electrode plate in an all-solid-state battery include the addition of a lithium salt, the use of a conductive binder, and the use of a solid electrolyte having high ion conductivity. That is, a method of improving ionic conductivity of a material or creating a secondary lithium ion movement path other than the solid electrolyte through an additive has been tried.

### SUMMARY

Embodiments are directed to an all-solid-state battery including a positive electrode plate including a positive electrode current collector and a positive electrode mixture layer on the positive electrode current collector, a solid electrolyte layer disposed on at least one side of opposite sides of the positive electrode plate, and a negative electrode plate positioned at a first side of the solid electrolyte layer, wherein the positive electrode mixture layer includes a groove having a depth in a stacking direction, and the solid electrolyte layer further includes a charging portion filled in the groove.

An embodiment of the present disclosure may provide an all-solid-state battery that improves ionic conductivity of a positive electrode plate. An embodiment may provide an all-solid-state battery that improves ionic conductivity in a positive electrode mixture layer by providing an ion conductive material in the positive electrode mixture layer.

In addition, an embodiment may provide an all-solid-state battery that improves ionic conductivity in a positive electrode mixture layer by forming grooves in the positive electrode mixture layer (hereinafter referred to as a “filling portion”) filling the grooves with a solid electrolyte, and connecting it to a solid electrolyte layer.

An embodiment may provide an all solid battery including a positive electrode plate including a positive electrode current collector and a positive electrode mixture layer on the positive electrode current collector, a solid electrolyte layer disposed on at least one side of opposite sides of the positive electrode plate, and a negative electrode plate positioned at a first side of the solid electrolyte layer, wherein the positive electrode mixture layer includes a groove having a depth in a stacking direction, and the solid electrolyte layer further includes a charging portion filled in the groove.

The negative electrode plate, the solid electrolyte layer, and the positive electrode plate may form one of a first stacked structure including the negative electrode plate, the solid electrolyte layer, the positive electrode plate, the solid electrolyte layer, and the negative electrode plate in this order, and a second stacked structure including the negative electrode plate, the solid electrolyte layer, and the positive electrode plate in this order.

The groove and the charging portion may have a first width at a side of the solid electrolyte layer in the stacking direction, and may have a second width that is smaller than the first width at a side of the positive current collector. An end of the first width and an end of the second width may be connected by an inclined surface.

The groove and the charging portion may have a first width at a side of the solid electrolyte layer in the stacking direction, and may have a point at a side of the positive current collector. An end of the first width and an end of the point may be connected by an inclined surface.

The groove and the charging portion may have a first width at a side of the solid electrolyte layer in the stacking direction, and may have a second width that is equal to the first width at a side of the positive current collector, and an end of the first width and an end of the second width may be connected to the positive electrode mixture layer by a vertical surface.

The positive electrode mixture layer may have a first height in the stacking direction, and the groove and the charging portion may have a second height that is smaller than the first height.

The groove may be formed in a plurality of circular shapes distributed over an entire area with respect to a plane of the positive electrode mixture layer.

The groove may be formed in a plurality of stripe structures distributed over an entire area with respect to a plane of the positive electrode mixture layer.

A ratio (H2/H1) of the second height (H2), which is a depth of the groove and the charging portion to the first height (H1), which is an entire thickness of the positive electrode mixture layer, may be set to 5 to 90%.

A first width (W1) of the groove and the charging portion may be 1 to 100 μm.

A first particle size of a solid electrolyte forming the solid electrolyte layer may be 2 to 5 μm.

A second particle size of a solid electrolyte forming the filling portion may have a particle size of 1 μm or less that is smaller than the first particle size.

A third particle size of the solid electrolyte included in the positive electrode mixture layer may be 0.1 to 2 μm.

The positive electrode mixture layer may further include an additional layer disposed on a surface in the stacking direction to increase ionic conductivity.

The additional layer may further include an inner layer disposed on an inner surface of the groove.

The filling portion of the solid electrolyte layer may be filled in the inner layer of the groove.

According to an embodiment of the present disclosure, the all-solid-state battery may improve the ionic conductivity of the positive electrode plate by providing the charging portion of the solid electrolyte layer in the groove of the positive electrode mixture layer to increase the lithium ion transfer area.

According to an embodiment, the all-solid-state battery may increase the lithium ion transfer area by providing an ion conductive material formed as a charging portion of the solid electrolyte layer in the groove of the positive mixture layer, thereby improving the ionic conductivity in the positive electrode mixture layer.

According to an embodiment, the all-solid-state battery may increase the lithium ion transfer area by filling the groove of the positive electrode mixture layer with a solid electrolyte and connecting it to the solid electrolyte layer, thereby improving the ionic conductivity in the positive electrode mixture layer.

### BRIEF DESCRIPTION OF THE DRAWINGS

Features will become apparent to those of skill in the art by describing in detail exemplary embodiments with reference to the attached drawings in which:

FIG. 1 illustrates a cross-sectional view showing a charging state of an all-solid-state battery according to a first embodiment of the present disclosure.

FIG. 2 illustrates an enlarged cross-sectional view of a portion of a positive electrode mixture layer of FIG. 1.

FIG. 3 illustrates a top plan view of the positive electrode mixture layer of FIG. 1.

FIG. 4 illustrates a top plan view of a positive electrode mixture layer applied to an all-solid-state battery according to a second embodiment of the present disclosure.

FIG. 5 illustrates a cross-sectional view showing a charging state of an all-solid-state battery according to a third embodiment of the present disclosure.

FIG. 6 illustrates a cross-sectional view showing a charging state of an all-solid-state battery according to a fourth embodiment of the present disclosure.

FIG. 7 illustrates a cross-sectional view showing a charging state of an all-solid-state battery according to a fifth embodiment of the present disclosure.

FIG. 8 illustrates an enlarged cross-sectional view of a portion of a positive electrode mixture layer of FIG. 7.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

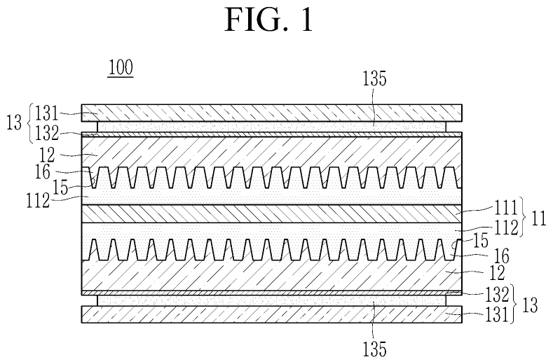

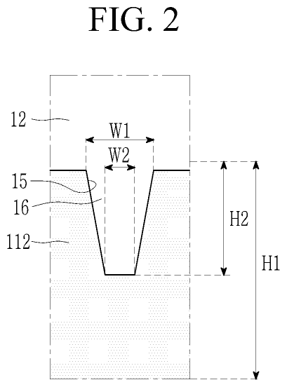

FIG. 1 illustrates a cross-sectional view showing a charging state of an all-solid-state battery according to a first embodiment of the present disclosure. FIG. 2 illustrates an enlarged cross-sectional view of a portion of a positive electrode mixture layer of FIG. 1.

Referring to FIG. 1 and FIG. 2, the all-solid-state battery 100 according to the first embodiment of the present disclosure includes a positive electrode plate 11, a solid electrolyte layer 12 disposed on at least one of opposite sides of the positive electrode plate 11, and a negative electrode plate 13 disposed at a first side of the solid electrolyte layer 12.

The negative electrode plate 13, the solid electrolyte layer 12 and the positive electrode plate 11 form a first stacked structure in the order of the negative electrode plate 13, the solid electrolyte layer 12, the positive electrode plate 11, the solid electrolyte layer 12, and the negative electrode plate 13.

In addition, although not illustrated separately, referring to FIG. 1, the negative electrode plate 13, the solid electrolyte layer 12, and the positive electrode plate 11 may form a second stacked structure in the order of the negative electrode plate 13, the solid electrolyte layer 12, and the positive electrode plate 11. The first stacked structure may be viewed as forming a second stacked structure at opposite sides while sharing the positive electrode plate 11.

The first stacked structure of the positive electrode plate 11, the solid electrolyte layer 12, and the negative electrode plate 13 may form a unit cell as a bi-cell. In addition, the second stacked structure of the positive electrode plate 11, the solid electrolyte layer 12, and the negative electrode plate 13 may form a unit cell as a mono-cell that functions to charge and discharge at a first side of the positive electrode plate 11 (not illustrated).

The positive electrode plate 11 may be formed by coating a positive electrode mixture layer 112 on a positive electrode current collector 111. According to the first embodiment, the positive electrode plate 11 may be configured to increase ionic conductivity. The positive electrode plate 11 may include the positive electrode mixture layer 112 formed by applying a slurry to opposite sides of the positive electrode current collector 111, which may be made of aluminum. That is, during charging and discharging, the positive electrode mixture layer 112 may allow lithium ions to enter and exit.

As an example, the positive electrode mixture layer 112 may include a positive electrode active material, a solid electrolyte, a binder, and a conductive material. In addition, the positive electrode mixture layer 112 may further include a lithium salt, a dispersing material, and a stabilizing material.

As an example, the positive electrode mixture layer 112 may form a groove 15 having a depth in a stacking direction. The solid electrolyte layer 12 may further include a portion 16 that is filled in the groove 15, hereinafter referred to as the “filling portion 16”. Referring to FIG. 2, the groove 15 and the filling portion 16 may be connected to an inclined surface having a first width W1 at a side of the solid electrolyte layer 12 in a stacking direction (vertical direction in FIG. 1 and FIG. 2), and a second width W2 that is smaller than the first width W1 at a side of the positive electrode current collector 111. As an example, the groove 15 and the filling portion 16 may have a trapezoid cross-section shape.

The positive electrode mixture layer 112 may be disposed on the positive electrode current collector 111, and thus, the groove 15 may be positioned on a surface of the positive electrode mixture layer 112 at an opposite side of the positive electrode current collector 111 along an inclined surface toward the positive electrode current collector 111.

The positive electrode mixture layer 112 may have a first height H1 in the stacking direction (vertical direction in FIG. 1 and FIG. 2). The first height H1 indicates a total thickness of the positive electrode mixture layer 112. The groove 15 and the filling portion 16, also referred to as the charging portion 16 formed in the positive electrode mixture layer 112 may have a second height H2 that is smaller than the first height H1. The second height H2 indicates a depth of the groove 15.

As an example, a ratio (H2/H1) of the second height H2, which is the depth of the groove 15, to the first height H1, which is the total thickness of the positive electrode mixture layer 112, may be set to be in a range of 5% to 90%. If the height ratio (H2/H1) were to be less than 5%, an increase in a lithium ion transfer area by the charging portion 16 relative to the total thickness of the positive electrode mixture layer 112 could be insignificant, such that there may be no effect from including the charging portion 16 in the groove 15.

If the height ratio (H2/H1) were to exceed 90%, there could be a high risk of generating metal foreign matter due to damage to the positive electrode current collector 111 during processing while excessively increasing the lithium ion transfer area by the charging portion 16 with respect to the total thickness of the positive electrode mixture layer 112. In addition, mixing of the generated metal foreign matter could result in a short circuit, performance degradation, and a lifespan reduction of the all-solid-state battery 100.

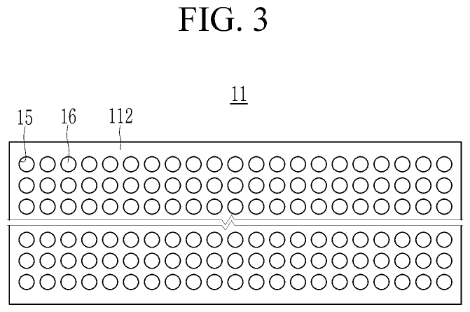

FIG. 3 illustrates a top plan view of the positive electrode mixture layer of FIG. 1. Referring to FIG. 1 to FIG. 3, if the groove 15 and the filling portion 16 are truncated cones, the terms “first width W1” and the “second width W2” may refer to diameters at opposite sides of the truncated cone. The groove 15 may be formed in a plurality of circular shapes distributed over an entire area with respect to a plane of the positive electrode mixture layer 112.

If the first height H1 and the second height H2 are set, the first width W1 and the second width W2 may define a cross-sectional area of the charging portion 16 and a volume of the charging portion 16 in the positive electrode mixture layer 112. As an example, the first width W1 and the second width W2 may be 1 μm to 100 μm, and the second height H2 may be smaller than the first height H1 and greater than 1 The groove 5 may be 4 to 500 EA/mm 2.

If the first width W1 were to less than 1 it could be difficult to fill the solid electrolyte to form the charging portion 16. If the first width W1 were to be greater than 100 the cell capacity and performance degradation of the all-solid-state battery 100 could be serious due to an increase in a loss of the positive electrode mixture layer 112 compared to a performance improvement,

In the first embodiment, the groove 15 and the filling part 16 have been described as a truncated cone, i.e., a truncated circular cone. Although not illustrated, in some implementations, the groove 15 and the charging portion 16 may be formed as a polygonal truncated zone or a nonlinear zone.

A first particle size of the solid electrolyte forming the solid electrolyte layer 12 may be 2 μm to 5 μm or 3 μm based on D50. If the particle size of the solid electrolyte were to be smaller than 2 resistance increases due to an increase in an interface, and ionic conductivity could decrease. If the particle diameter of the solid electrolyte were to be greater than 5 μm, a contact path of the solid electrolyte for movement of lithium ions could be reduced and the ionic conductivity could be lowered. D50, which is also called a median particle size, may refer to a size of a cumulative percentage of 50% of a particle size distribution of the material. D50 has a typical property used to indicate a particle size in production and application of powder materials.

If the solid electrolyte of the solid electrolyte layer 12 were to have a particle size of 2 to 5 μm or a particle size of 3 μm based on D50, resistance could be reduced due to interface reduction, and movement of lithium ions could be reduced, thereby improving ionic conductivity.

If the first width W1 is 1 to 100 the second particle size of the solid electrolyte filling the groove 15 to form the charging unit 16 may have a particle size of 1 μm or less based on D50. The solid electrolyte with a particle size of 1 μm may enable filling of the groove 15 and may improve the contact path within the groove 15 in a filled state.

A third particle size of the solid electrolyte included in the positive electrode mixture layer 112 may be a particle size of 0.1 to 2 μm or 1 μm based on D50. If the particle diameter of the solid electrolyte were to be smaller than 0.1 dispersibility could be reduced, and if the particle size were to be greater than 2 ion conductivity could be reduced due to insufficient contact with the positive electrode active material and a reduced contact path with the solid electrolyte for movement of lithium ions.

The second particle size of the solid electrolyte forming the charging portion 16 may have a particle size of 1 μm or less. The third particle size of the solid electrolyte included in the positive electrode mixture layer 112 may be a particle size of 0.1 to 2 The second particle size may be smaller than or equal to the third particle size (second particle size≤third particle size).

As an example, in order to manufacture the positive electrode plate 11, a positive electrode slurry may be applied first to a surface of the positive electrode current collector 111 and then may be dried to form the positive electrode mixture layer 112.

A pattern of the groove 15 is positioned on the surface of the positive electrode mixture layer 112 by laser processing or by using a needle mold press. The solid electrolyte slurry may be coated onto the positive electrode mixture layer 112 or the positive electrode plate 11 in which the pattern of the groove 15 is to be formed to provide the charging portion 16.

In the present disclosure, the solid electrolyte slurry may be of two types. For example, the solid electrolyte slurry may include a solid electrolyte slurry for forming the filling portion 14 and a slurry for forming the solid electrolyte layer 12. Each slurry may include solid electrolyte particles having different particle diameters.

For example, the solid electrolyte slurry for forming the filling part 14 may include solid electrolyte particles having a second particle size, and the solid electrolyte slurry for forming the solid electrolyte layer 12 may have a particle diameter of 2 to 5 μm or 3 μm based on D50.

Methods for coating the solid electrolyte slurry may include screen coating, die coating, and spray coating. The coated positive electrode plate 11 may be pressed by a sheet roll press.

Through the above-described method, the filling portion 14 may be formed inside the groove 15. In this process, an extension (not illustrated) may be formed outside the groove 15, i.e., on at least a portion of a surface of the positive electrode mixture layer 112 on which the groove 15 is not formed. The extension may include solid electrolyte particles having a second particle size, and may or may not be removed through a separate process later.

On the other hand, in order to manufacture the solid electrolyte layer 12, the solid electrolyte slurry for forming the solid electrolyte layer 12 may be applied to a surface of the negative electrode plate 13 or a negative electrode mixture layer 123, and then dried to form the solid electrolyte layer 12.

Later, the positive electrode mixture layer 112 on which the charging portion 16 is formed and the negative electrode plate 13 or the negative electrode mixture layer 123 on which the solid electrolyte layer 12 is formed may be pressed together to manufacture the all-solid battery 100. In this case, a roll press and a warm isostatic press (WIP) may be used for the compression method, as a non-limiting example.

The all-solid-state battery 100 may move lithium ions by way of a connection between solid electrolyte particles forming the solid electrolyte layer 12. The charging portion 16 filled in the groove 15 may be formed of a solid electrolyte to increase the lithium ion transfer area between the solid electrolyte layer 12 and the positive current collector 111.

In a portion not provided with the groove 15 and the charging portion 16, the positive electrode mixture layer 112 may form a lithium ion transfer path that corresponds to the first height H1. The positive electrode mixture layer 112 may form a lithium ion transfer area corresponding to the portion of the lithium ion transfer area not provided with the groove 15 and the charging portion 16.

Then, in the portion provided with the groove 15 and the charging portion 16, the positive electrode mixture layer 112 may form a lithium ion transfer path corresponding to a difference (H1−H2) between the first height H1 and the second height H2. The positive electrode mixture layer 112 may form a lithium ion transfer area corresponding to a surface area of the charging portion 16. The groove 15 and the charging portion 16 may further increase the lithium ion transfer area as compared to a case where the groove 15 and the charging portion 16 are not provided.

That is, the lithium ion transfer area is increased in the positive electrode mixture layer 112 and the positive electrode plate 11. Accordingly, the ionic conductivity of lithium ions in the positive electrode mixture layer 112 and the positive electrode plate 11 may be improved. During charging and discharging, the generation of lithium dendrite by lithium ions may be reduced.

When the charging portion 16 is formed as much as the second height H2 in the first height H1 of the positive electrode mixture layer 112, the generation of lithium dendrites in the portion corresponding to the second height H2 may be prevented. In a remaining portion of the positive electrode mixture layer 112, the lithium ion transfer area may be increased by the surface area of the groove 15 and the charging portion 16. Accordingly, the generation of lithium dendrite may be reduced and the generation of lithium dendrites for an entire height of the positive electrode mixture layer 112, i.e., the first height H1, may be reduced.

In addition, the charging portion 16 may be formed in the first width W1 and the second width W2 of the entire area of the positive electrode mixture layer 112. The generation of lithium dendrites may be prevented in portions corresponding to the first width W1 and the second width W2. In a remaining portion of the positive electrode mixture layer 112, the lithium ion transfer area may be increased by the surface area of the groove 15 and the charging portion 16, such that the generation of lithium dendrites may be reduced. Accordingly, the generation of lithium dendrites with respect to the entire area of the positive electrode mixture layer 112 may be reduced.

The filling portion 14 of the solid electrolyte layer 12 may be provided in the groove 15 of the positive electrode mixture layer 112. Thus, the all-solid-state battery 100 according to the first embodiment may have improved ion conductivity compared to an all-solid-state battery having a positive electrode plate in which a groove and a charging portion are not processed.

Referring again to FIG. 1, a lithium precipitation layer 135 may not be formed in a discharged state, but may be formed in the charged state. Lithium ions may pass through the charging portion 16 of the groove 15 and the solid electrolyte layer 12 in the positive electrode mixture layer 112 of the positive electrode plate 11 to precipitate at a first side of the negative electrode current collector 131.

In the first embodiment, the negative electrode plate 13 may be formed by including the negative electrode mixture layer 132 in the negative electrode current collector 131. Although not illustrated, the negative electrode plate may be formed as a negative electrode current collector without the negative electrode mixture layer.

During discharging, lithium ions of the lithium precipitation layer 135 may be dissociated and may pass through the solid electrolyte layer 12 and the charging unit 16 to move to the positive electrode mixture layer 112 of the positive electrode plate 11 so that the lithium precipitation layer 135 disappears.

In this way, the charging portion 16 formed of the solid electrolyte in the groove 15 may increase the lithium ion transfer area between the charging portion 16 and the positive current collector 111. That is, the lithium ion transfer area between the anode current collector 111 and the solid electrolyte layer 12 may be increased. The charging portion 16 may increase the lithium ion transfer area between the solid electrolyte layer 12 and the positive electrode current collector 111 during charging and discharging, scuh that the ionic conductivity of the positive electrode mixture layer 112 and the positive electrode plate 11 may be improved.

Hereinafter, various embodiments of the present disclosure will be described. Compared to the first embodiment and the previously described embodiments, descriptions of the same components will not be repeated, and descriptions of different components will be described.

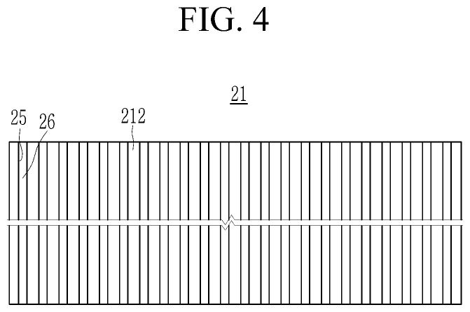

FIG. 4 illustrates a top plan view of a positive electrode mixture layer applied to an all-solid-state battery according to a second embodiment of the present disclosure. Referring to FIG. 4, in the positive electrode plate 21, the groove 25 may be formed in a plurality of stripe structures distributed over an entire area with respect to a plane of a positive electrode mixture layer 212. The stripe structure may be formed by connecting the circles of the first embodiment in a direction.

A groove 25 of the stripe structure may form a larger area with respect to a plane of the positive electrode mixture layer 212 if intervals are equal to each other compared to the circular groove 15. Accordingly, the charging portion 26 of the groove 25 may further increase the lithium ion transfer area during charging and discharging between the solid electrolyte layer 12 and the positive current collector 111, compared to the groove 15 and the charging portion 16 of the first embodiment.

Generation of lithium dendrites may be further prevented as much as the groove 25 of the stripe structure is wider than the groove 15 of the circular structure in an entire area of the positive electrode mixture layer 212 of the charging portion 26. Accordingly, the generation of lithium dendrites with respect to the entire area of the positive electrode mixture layer 212 may be further reduced.

Therefore, the filling portion 14 of the groove 25 of the stripe structure according to the second embodiment may further improve ionic conductivity in the positive electrode mixture layer 212 and in the positive electrode plate 11 compared to the filling portion 16 of the circular structural groove 15 of the first embodiment.

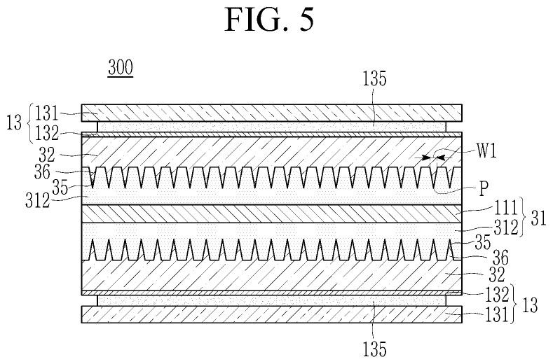

FIG. 5 illustrates a cross-sectional view showing a charging state of an all-solid-state battery according to a third embodiment. Referring to FIG. 5, in a positive electrode mixture layer 312 of the all-solid-state battery 300 according to the third embodiment, a groove 35 and a charging portion 36 have a first width W1 at a side of a solid electrolyte layer 32 in a stacking direction and may include a point P at a side of the positive current collector 111. An end of the first width W1 and the point P are connected to the positive electrode mixture layer 312 of the positive electrode plate 31 by an inclined surface. The groove 35 and the filling portion 36 form a triangular cross-sectional structure.

If the first height H1 and the second height H2 were to be the same in the first embodiment and the second embodiment, the lithium ion transfer area between the solid electrolyte layer 32 and the positive electrode current collector 111 due to the groove 35 and the charging portion 36 of the third embodiment could be smaller than the lithium ion transfer area between the solid electrolyte layer 12 and the positive current collector 111 due to the groove 15 and the charging portion 16 of the first embodiment.

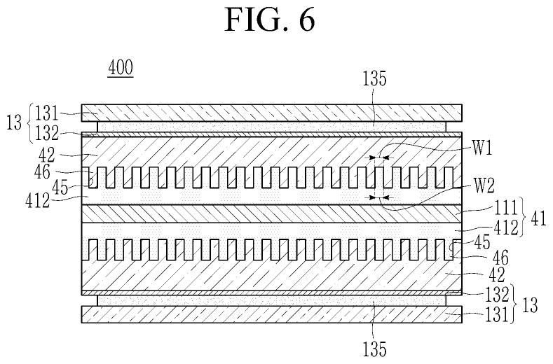

FIG. 6 illustrates a cross-sectional view showing a charging state of an all-solid-state battery according to a fourth embodiment of the present disclosure. Referring to FIG. 6, in a positive electrode mixture layer 412 of the all-solid-state battery 400 according to the fourth embodiment, a groove 45 and a charging portion 46 may have a first width W1 at a side of a solid electrolyte layer 42 in a stacking direction and a second width W2 that is equal to the first width W1 at a side of the positive electrode current collector 111. An end of the first width W1 and an end of the second width W2 may be connected to the positive electrode mixture layer 412 of the positive electrode plate 41 in a vertical surface. The groove 45 and the filling portion 46 may form a quadrangular cross-sectional structure.

If the first height H1 and the second height H2 are the same in the first embodiment and the fourth embodiment, the lithium ion transfer area between the solid electrolyte layer 42 and the positive electrode current collector 111 due to the groove 45 and the charging portion 46 of the fourth embodiment may be greater than that of the lithium ion transfer area between the solid electrolyte layer 12 and the positive current collector 111 due to the groove 15 and the charging portion 16 as shown in the first embodiment.

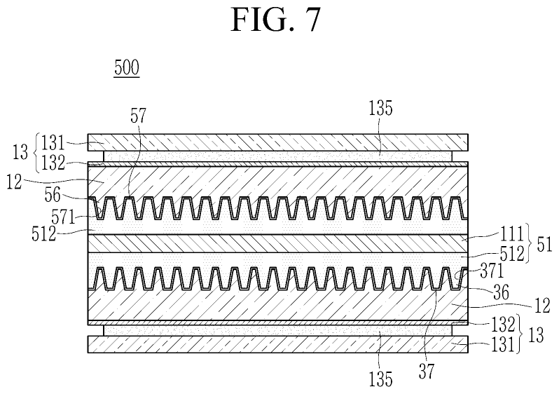

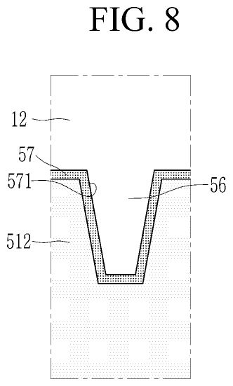

FIG. 7 illustrates a cross-sectional view showing a charging state of an all-solid-state battery according to a fifth embodiment of the present disclosure. FIG. 8 illustrates an enlarged cross-sectional view of a portion of a positive electrode mixture layer of FIG. 7.

Referring to FIG. 7 to FIG. 8, in a positive electrode plate 51 of the all-solid-state battery 500, the positive electrode mixture layer 512 may further include an additional layer 57 disposed on a surface in a stacking direction to increase ionic conductivity. The additional layer 57 may be formed of a material having higher ionic conductivity than that of the positive electrode mixture layer 512.

The additional layer 57 may further include an inner layer 571 disposed on an inner surface of the groove 15. The inner layer 571 may be disposed on the inner surface of the groove 15, and may be formed of a material having higher ionic conductivity than that of the inner surface of the groove 15 formed as the positive electrode mixture layer 512.

A filling portion 56 of a solid electrolyte layer 52 may be filled in the inner layer 571 of the groove 15. Accordingly, the inner layer 571 and the additional layer 57 may be formed of a material having higher ionic conductivity than that of the solid electrolyte layer 52.

In addition, the additional layer 57 may improve ionic conductivity between the positive electrode mixture layer 512 and the solid electrolyte layer 52, and the inner layer 571 may improve ionic conductivity between the inner surface of the groove 15 and the charging portion 56.

As such, the additional layer 57 and the inner layer 571 of the third exemplary embodiment may further improve the ionic conductivity between the positive electrode mixture layer 512 and the solid electrolyte layer 12 compared to the first embodiment. Thus, the generation of lithium dendrites may be further prevented while the ionic conductivity may be improved. Accordingly, the generation of lithium dendrites with respect to the entire area of the positive electrode mixture layer 512 is further reduced.

Although the additional layer 57 and the inner layer 571 are distinguished in the third embodiment, they need not be distinguished. In some implementations, the additional layer 57 and the inner layer 571 may be unified and described as the ‘additional layer 57’. The additional layer 57 may be positioned between the positive electrode mixture layer 512 and the charging portion 56 to fill in any gaps that may exist, thereby increasing ionic conductivity and minimizing dendrite generation.

As an example, the additional layer 57 may be formed of at least one of Li₃PO₄, LiNbO₃, Li₇La₃Zr₂O₁₂, Li₂TiO₃, Li₃B₁₁O₁₈, Li₃B₇O₁₂, LiBO₂, Li₂B₄O₇, Li₆B₄O₉, Li₂Si₂O₅, Li₄Ti₅O₁₂, Li₄Ge₅O₁₂, Li₂GeO₃, Li₃AsO₄, Li₂Ti₆Zn₃O₁₆, Li₂Ti₃ZnO₈, Li₂TiGeO₅, LiTiPO₅, BaLi₂Ti₆O₁₄, SrLi₂Ti₆O₁₄, or Li₂MgTi₃O₈.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

| | |
|---|---|
| 11, 21, 31, 41, 51: positive electrode plate | 12, 32, 42: solid electrolyte layer |
| 13: negative electrode plate | 15, 25, 35, 45: groove |
| 16, 26, 36, 46, 57: charging portion | 57: additional layer |
| 100, 300, 400, 500: all-solid-state battery | 111: positive electrode current collector |
| 112, 212: positive electrode mixture layer | 312, 412, 512: positive electrode mixture layer |
| 131: negative electrode current collector | 132: negative electrode composite layer |
| 135: lithium precipitation layer | 571: inner layer |
| H1: first height | H2: second height |
| W1: first width | W2: second width |

What is claimed is:

1. An all-solid-state battery comprising:
a positive electrode plate including a positive electrode current collector and a positive electrode mixture layer on the positive electrode current collector;
a solid electrolyte layer disposed on at least one side of opposite sides of the positive electrode plate; and
a negative electrode plate positioned at a first side of the solid electrolyte layer,
wherein the positive electrode mixture layer includes a groove having a depth in a stacking direction, and
the solid electrolyte layer further includes a charging portion filled in the groove.

2. The all-solid-state battery as claimed in claim 1, wherein
the negative electrode plate, the solid electrolyte layer, and the positive electrode plate form one of a first stacked structure including the negative electrode plate, the solid electrolyte layer, the positive electrode plate, the solid electrolyte layer, and the negative electrode plate in this order, and
a second stacked structure including the negative electrode plate, the solid electrolyte layer, and the positive electrode plate in this order.

3. The all-solid-state battery as claimed in claim 2, wherein
the groove and the charging portion have a first width at a side of the solid electrolyte layer in the stacking direction, and have a second width that is smaller than the first width at a side of the positive current collector, and
an end of the first width and an end of the second width are connected by an inclined surface.

4. The all-solid state battery as claimed in claim 2, wherein
the groove and the charging portion have a first width at a side of the solid electrolyte layer in the stacking direction, and have a point at a side of the positive current collector, and
an end of the first width and an end of the point are connected by an inclined surface.

5. The all-solid-state battery as claimed in claim 2, wherein
the groove and the charging portion
have a first width at a side of the solid electrolyte layer in the stacking direction, and have a second width that is equal to the first width at a side of the positive current collector, and
an end of the first width and an end of the second width are connected to the positive electrode mixture layer by a vertical surface.

6. The all-solid-state battery as claimed in claim 2, wherein
the positive electrode mixture layer has a first height in the stacking direction, and
the groove and the charging portion have a second height that is smaller than the first height.

7. The all-solid-state battery as claimed in claim 2, wherein
the groove is formed in a plurality of circular shapes distributed over an entire area with respect to a plane of the positive electrode mixture layer.

8. The all-solid-state battery as claimed in claim 2, wherein
the groove is formed in a plurality of stripe structures distributed over an entire area with respect to a plane of the positive electrode mixture layer.

9. The all-solid-state battery as claimed in claim 6, wherein
a ratio (H2/H1) of the second height (H2), which is a depth of the groove and the charging portion to the first height (H1), which is an entire thickness of the positive electrode mixture layer, is in a range of 5 to 90%.

10. The all-solid-state battery as claimed in claim 2, wherein
a first width (W1) of the groove and the charging portion is 1 to 100 μm.

11. The all-solid-state battery as claimed in claim 10, wherein
a first particle size of a solid electrolyte forming the solid electrolyte layer is 2 to 5 μm.

12. The all-solid-state battery as claimed in claim 11, wherein
a second particle size of a solid electrolyte forming a filling portion has a particle size of 1 μm or less and that is smaller than the first particle size.

13. The all-solid-state battery as claimed in claim 12, wherein
a third particle size of the solid electrolyte included in the positive electrode mixture layer is 0.1 to 2 μm.

14. The all-solid-state battery as claimed in claim 2, wherein
the positive electrode mixture layer further includes an additional layer disposed on a surface in the stacking direction to increase ionic conductivity.

15. The all-solid-state battery as claimed in claim 14, wherein
the additional layer further includes an inner layer disposed on an inner surface of the groove.

16. The all-solid-state battery as claimed in claim 15, wherein
a filling portion of the solid electrolyte layer is filled in the inner layer of the groove.
